(19) United States
(12) Patent Application Publication
(10) Pub. No.: US 2010/0057972 A1
(43) Pub. Date: Mar. 4, 2010

(54) VIDEO DATA TRANSMISSION VIA USB INTERFACE

(75) Inventors: Oliver Stangl, Regensburg (DE); Andreas Mihalovits, Regensburg (DE); Elias Indrich, Zurich (CH); Roland Peffer, Regensburg (DE)

Correspondence Address: CONNOLLY BOVE LODGE & HUTZ LLP, 1875 EYE STREET, N.W., SUITE 1100, WASHINGTON, DC, 20006, US

(73) Assignee: record4free.tv AG, Glarus (CH)

(21) Appl. No.: 12/531,696

(22) PCT Filed: Mar. 14, 2008
(86) PCT No.: PCT/EP2008/002078

§ 371 Date: Nov. 9, 2009

(30) Foreign Application Priority Data
Mar. 26, 2007 (EP) 07090058.4

(51) Int. Cl. G06F 13/14

(52) U.S. Cl. 710/305

(57) ABSTRACT

The invention relates to a method for the transmission of video data from a data source to a data sink, wherein the transmission is carried out via a USB interface, wherein the information transmitted via the USB interface represents the digital values of a YUV signal, wherein the digital values of the YUV signal are fed to a video encoder, particularly in the form of a video DAC, in the data sink.

The present invention relates to a method of transmitting video data from a data source to a data sink, the transmission being carried out via a USB interface, and to a device for carrying out the method.

Multimedia data in the form of digitised images and sounds is used in almost all technical fields, and for transmission the requirements which the resolution and compression of the image data are called upon to meet are highly diversified in this case. If the digital images are to meet stringent demands, only a relatively small amount of compression may take place before transmission, because information is lost as compression increases and the quality of the images suffers. With normal videos, the amount of data required is generally several megabytes per image if it is to be ensured that the images are of good quality.

The transmission of large quantities of data of this kind, and the advantageous processing of the quantities of data for fast and efficient use, are known in the prior art.

In this way, DE 101 20 806 B4 describes a device and a method for transmitting multimedia data objects from a central data source via a data network to a plurality of terminals, preferably television sets, which are connected to the data network via additional devices, the objects being converted to a format suitable for data transmission and fed onto the data network by the central data source by means of a central feed-on unit, the central feed-on unit being a code converter which digitises the data objects obtained from the central data source, converts them into a digital data stream, feeds this data stream continuously onto the data network and transmits it to the additional units which are connected in.

The transmission of multimedia data over a network is conventionally performed by means of known method of encoding and compression such for example as the MPEG method, in which various mathematical processes are applied in the context of the compression and de-compression of the image data. Significant steps in video compression are the reduction of redundancy, in the form of a lossless, reversible process based on the statistics of the input signal. In most cases, what is often then done as part of the video compression is a so-called reduction of irrelevance, in which use is made of the special characteristics of the audio-visual perception of the human eye and ear, this being for example hybrid encoding in which, as in the case of the MPEG standard, account is taken of psycho-optical and psycho-audio perception. In video compression, these steps of the process generally take the form of a de-correlating image transformation, quantising which, as an option, may be lossy, and lossless entropy encoding. Examples of de-correlating transformations of this kind are discrete cosine transformation (DCT) or discrete wavelet transformation (DWT). Where discrete cosine transformation is usually used is as a de-correlating transformation in video encoding processes such as MPEG or in digital television. Discrete wavelet transformation is used in the new JPEG 2000 image compression standard. This is general state of the art as described in, for example, DE 699 07 929 T2, DE 696 32 622 T2, DE 601 19 499 T2 or DE 692 10 698 T2.

The transmission of multimedia data is usually carried out using the methods of encoding/decoding pointed out above. The limited capacity of storage media and the limited options for transmission by means of a network are another reason for this. Encoding and decoding however require additional money to be spent on the hardware and this makes the equipment expensive to produce and additional licenses have to be taken out for the encoding and decoding processes. At least a storage module and an encoding chip or signal processing unit are needed to allow the encoding and decoding processes to be implemented in hardware form. The hardware is then generally confined to one or more formats for the transmission of the data.

Because multimedia data is generally transmitted in compressed form, transmission in uncompressed form, such for example as in the YUV image data format as described in DE 695 13 841 T2, is not something that is often done. At the present time the transmission of uncompressed data is only possible via the network interface, due to the high transmission rate (DE 602 11 157 T2).

A USB (universal serial bus) interface is a special interface for a computer which is used in particular to connect and disconnect peripherals, such for example as the keyboard and mouse, and memories, so-called USB sticks. The data processes which this involves are part of the prior art and are known for example from DE 199 00 345 A1. DE 102 11 054, A1 describes a USB host controller for handling the data traffic between at least one USB device and a system memory of a computer system. The USB host controller comprises a data fetching means for fetching items of data from the system memory, a memory means for storing the items of data which have been fetched, and a transaction processing means for processing transactions which are transmitted to the USB device or received therefrom, as a function of the items of data which have been fetched and which are stored in the memory means.

Depending on the standard employed, the USB interface is able to transmit data at different transmission rates. Also, the data can be transmitted in different modes of transmission, such as the bulk mode, isochronous mode, transfer mode or interrupt mode.

In the bulk mode, up to 480 Mbyte/s is available under the USB 2.0 standard. These bytes can be transmitted by the USB controller via a plurality of pipes. Data transmission per pipe in the bulk mode is approx. 20 packets each of 512 bytes per microframe, and a total of up to 8,000 microframes can be despatched. This results in a maximum transfer rate of approximately 82 Mbyte/s. If a USB device which is connected in is allotted the full transfer rate, video can be transmitted uncompressed in the bulk mode over the USB interface without any problems. If however there are a plurality of USB devices connected to a computer and if data is transmitted simultaneously over the individual USB interfaces, then the available band-width allotted to each individual USB device soon drop below a critical level and there are unwanted disruptions to the transmission process because the bulk mode only operates by the handshake procedure. If one USB device is transmitting in the bulk mode, then other USB devices can be operated in a different mode, such as the isochronous mode for example. The isochronous mode always takes precedence in this case, which means that while data is being transmitted to or from the USB device connected in the isochronous mode, data transmission is not possible for the USB device which is being operated in the bulk mode.

The isochronous mode was introduced as a mode for data transmission where time was critical, such for example as the streaming of audio/video files. The disadvantage with the isochronous mode is that band-width is limited to a maximum of 24.5 Mbyte/s for each USB device operated in the isochronous mode.

The development of the YUV colour model goes back to the development of analogue colour television under the PAL standard. It is also used today in analogue NTSC colour television. In it, the brightness (luminance) and colour (chrominance) of each pixel is determined. The YUV image data format in which the data can be generated in this case is 4:2:0, 4:2:2 or 4:4:4. What also exists is the UYUV format which is identical to 2:2:2. The use of a YUV image data format gives the advantage that the image data formats needed for a television set (PAL/SECAM/NSTC) can readily be generated by this means. What has become established for standard video is a system using fixed scanning of the individual images at a frequency of 13.5 MHz. In PC-slanted environments, one data word for luminance and chrominance is generated for each scan (4:2:0). A data word has 8 bits, which gives a data rate required for video transmission of 27 Mbyte/s. Hence, without compression/de-compression transmission in the isochronous mode would not be possible over the 2.0 USB interface, which would mean that costly electronics would be needed in a USB device, at least for de-compression.

It is an object of the present invention to provide a method and a device which allow error-free transmission of uncompressed multimedia data via a USB interface by using simple means.

This object is achieved in accordance with the invention by a method having the features given in claim 1. Further advantageous embodiments of the method according to the invention as claimed in claim 1 can be seen from the features given in the dependent claims.

The idea on which the invention is based is to transmit the data via the USB interface in uncompressed form in the YUV format. This being the case, the data received from the USB device is fed simply to a commercially available video DAC, which means that the video data can be fed straight to a television set as a PAL or NTSC signal. Hence it is possible for video data to be transmitted from a computer via the USB interface to a television set without any costly electronics.

For this purpose, the invention makes provision for a plurality of embodiments for the transmission of data via the USB interface. In this way, a first embodiment of the invention makes provision for the complete YUV signal to be transmitted and fed to the video DAC in the bulk mode.

In a further version of this first embodiment, the computer, as the sending data source, always monitors whether a sufficiently large band-width is available for the USB device which is connected in and receiving. If a sufficiently large band-width is not available in the bulk mode or other USB devices are operating in a mode which is preferred to the bulk mode, a switch can automatically be made to the isochronous mode, the data for the blanking interval then not being transmitted or not being transmitted in full and being brought back up to size again by the USB device following the reception of the rest of the image data, which means that a complete image signal is fed to the downstream video DAC.

However, in practice the bulk mode is generally not suitable for video streaming because it is the USB transmission mode which has the lowest priority on the system. As soon as there are other USB processes running in the interrupt mode or isochronous mode, it is interrupted, and there will thus undoubtedly be disruptions to the picture. For this reason, the isochronous mode which defines a given data rate at a given time is brought into play.

A second possible embodiment of the invention makes provision for the YUV image data always to be transmitted via the USB interface in the isochronous mode, the data for the blanking interval then either not being transmitted at all or only part of it being transmitted. Following the reception of the rest of the image data, the USB device then inserts the missing data words for the blanking interval back into the received data stream, and a complete image signal is thus once again fed to the downstream video DAC.

The cutting out of the entire blanking interval, and preferably the horizontal blanking interval, or only a part thereof, is preferably performed in the data source, i.e. in the computer.

The data which is transmitted arrives in all the embodiments at a buffer memory which belongs to the USB controller of the data sink in the form of a USB device which is connected to the data source. The buffer member is generally a FIFO memory, i.e. the data which is written into the FIFO first is also the first to be read out from it.

One complete line of a video image comprises 1728 data words under the PAL system and 1732 data words under the NTSC system. Of these, 1440 data words are in the visible part of the line under the PAL system. 2×4 data words per line are required for control purposes. This gives 1448 data words to be transmitted per image line under the PAL system. The other 280 data words (bytes) correspond to the length of the horizontal blanking interval and do not have to be transmitted, i.e. no image information is lost if these data words are cut out. However, it does have to be ensured that the 1728 data words under the PAL system are still fed per line to the video DAC in the USB device if the intention is for the synchronisation of the video signal to be maintained. Hence, for 1448 data words needing to be transmitted, the band-width requirement which arises is 22.6 Mbyte/s (=27 Mbyte/s*1448/1728). This required band-width is less than the band-width of 24 Mbyte/s which is guaranteed to be available in the isochronous mode.

In the second embodiment, in which the data for the blanking interval is entirely or completely untransmitted to reduce the amount of data, various methods may be used to add the missing data for the blanking interval back into the data stream at the end where the USB device is situated.

In this way, it is possible in a first variant for the data sink, or rather its USB controller, to itself generate the missing data for the blanking interval. Because there is not a control unit which itself analyses the data in the data stream, the clock-signal differences between the data source and the data sink have to be corrected for because the PC and USB device both have separate clock generators neither of which ever runs exactly at the frequency of 27 MHz which is specified as a nominal clock frequency. Because of the differences between the system clock signals, different data rates arise in operation and because the USB controller only has an 8 Kbyte memory these result in an overrun or underrun at the said USB controller. In the first variant, the differences between the clock signals are corrected for by means of a synchronisation of the data source and data sink. If the horizontal blanking interval is not transmitted, the different data rate which arises due to the different system clock signals is corrected for as follows: The USB controller calculates the difference between the clock signals by measuring the length of each transmitted image line in a frame. This value is transmitted back to the PC for each line. The PC can correct the downward/upward deviation of the data rate by varying the line length, which it does by also including a larger or smaller amount of data in the transmission for the next frame. It is immaterial in this case whether the data for the blanking interval, either all of it or only some of, is not included in the transmission. The USB controller at the data sink generates the rest of the data, for the blanking interval, to bring the data rate to a figure of exactly 27 Mbyte/s for the video DAC. This synchronization always re-adjusts itself automatically with a small latency time.

If the data for the vertical blanking interval has to be generated, the USB controller calculates the difference between the clock signals and generates the missing data. However, it must be borne in mind that additional control data may be included in the vertical blanking interval. Because of this fact too and the fact that 27 Mbyte/s can never be achieved exactly with this method, the video DAC will as a rule not be able to produce a stable PAL image. For this reason, synchronisation by means of the horizontal blanking interval is to be preferred.

In a second variant of the second embodiment, the control data included in the data stream, such for example as the end-of-line signal, is used to notify the USB controller which is transmitting of what data it has to transmit to the US device and what data it does not. The USB controller of the USB device which is receiving, or rather the latter's FIFO memory, is controlled by reference to the control data present in the data stream, such for example as the end-of-line signal. For this purpose, a check is made on, in particular, the byte, i.e. data word, which was the last to be read out of the FIFO memory at the time to see whether it represents the end-of-line signal. If the end-of-line signal is detected, the read-out from the FIFO memory is stopped and the USB controller or an additional data generator generates data words for the blanking interval which are fed to the video DAC in a continuous sequence. During this time, the image information for the next image line remains in the FIFO memory. Provided the FIFO memory is not yet completely full, it is filled up with succeeding video data by the USB controller via the USB interface. As soon as a sufficient number of items of blanking interval data have been transmitted to the video DAC, the read-out of the FIFO memory starts again. If the entire blanking interval is being omitted from the transmission, then with the PAL, system the read-out of the FIFO memory always has to be stopped, and the data for the blanking interval generated, for 280 clock pulses. If some of the items of blanking interval data are being included in the transmission via the USB interface then the number of these has to be known or analysed by the USB device so that the FIFO memory can be stopped, and the missing items of the data for the blanking interval can be generated, for an appropriate number of clock pulses. Because the control of the FIFO memory is tied in a fixed way to the control words for visible parts of lines, and particularly the end-of-line data, and to the generation of the patterns of data for the missing blanking interval, there is, advantageously, a guarantee of a stable video output.

The generation of the data for the blanking interval and the control of the FIFO memory can be performed very easily by means of a programmable logic module. It is also possible for a complex programmable logic device, also known as a CPLD, to be used.

The invention will be explained below by reference to drawings. In the drawings:

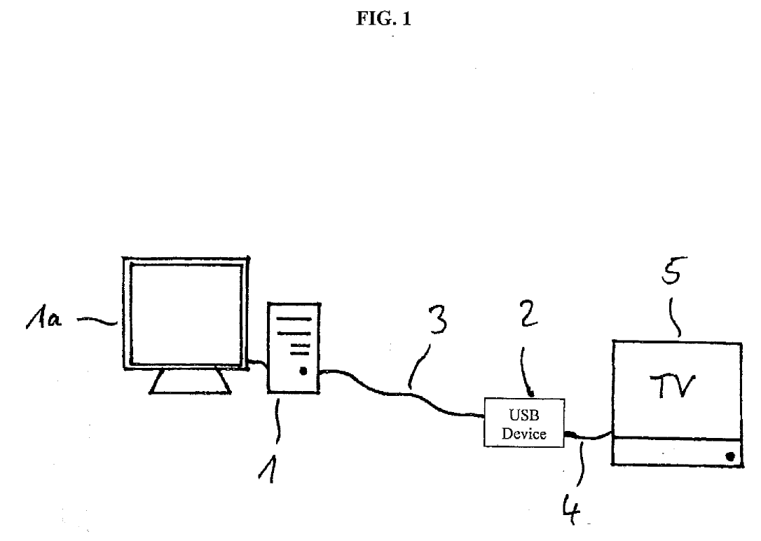

FIG. 1 shows the connections between the computer, USB device and TV set.

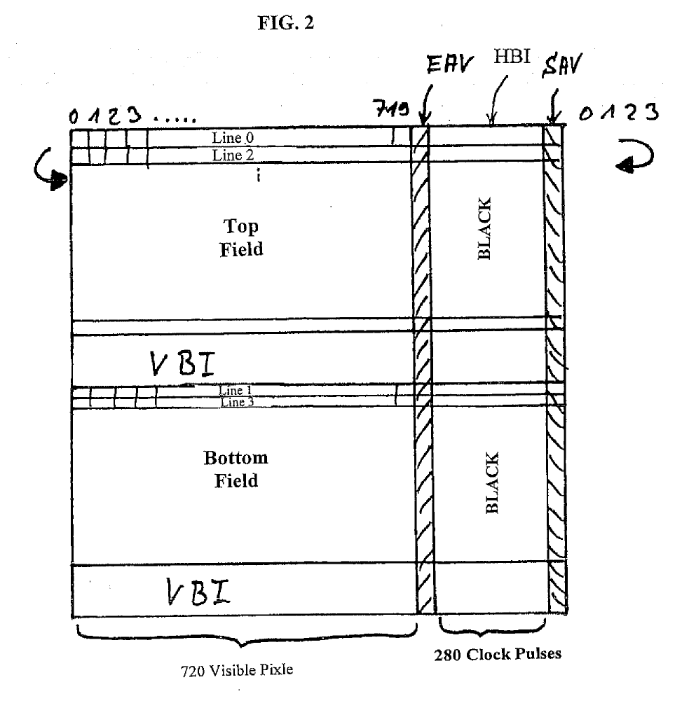

FIG. 2 shows the make-up of a digital YUV video signal

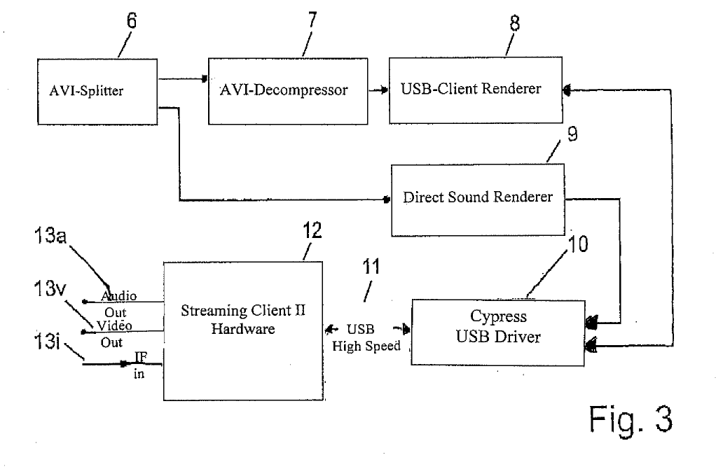

FIG. 3 is a block circuit diagram of the path followed by the data stream from the data source to the data sink.

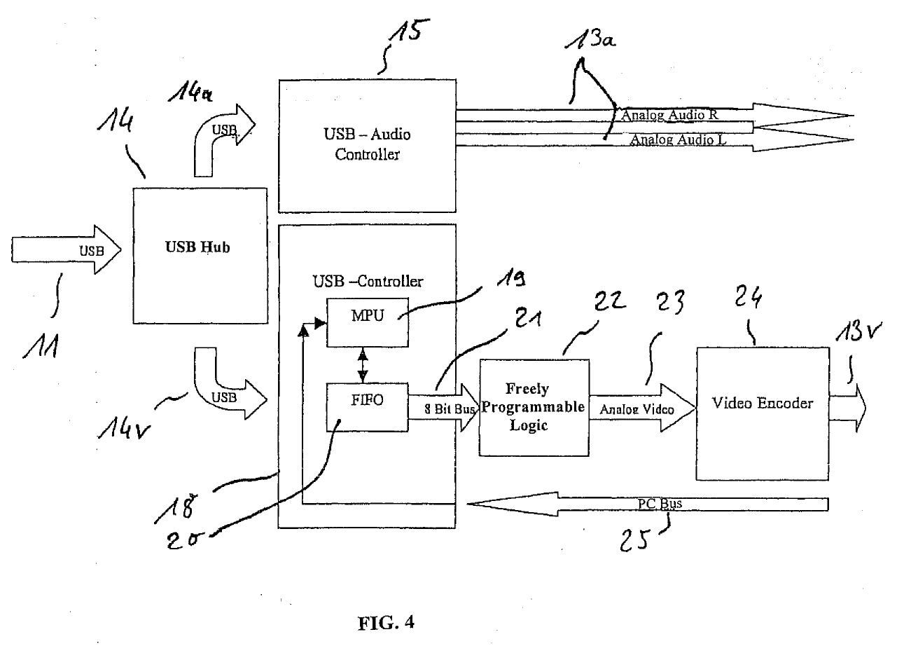

FIG. 4 is a block circuit diagram of the USB device as a streaming client.

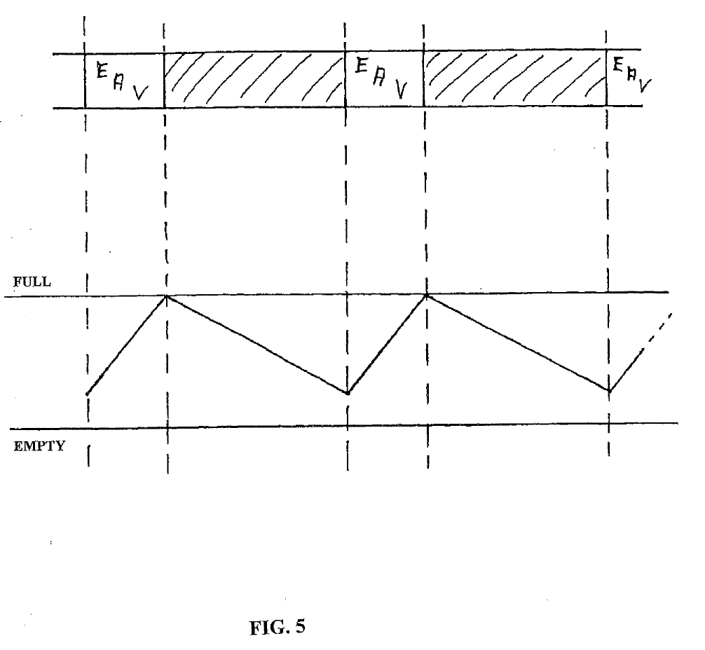

FIG. 5 shows YUV signal data and the occupancy of the FIFO memory of the USB controller of the USB device when the USB isochronous mode is used.

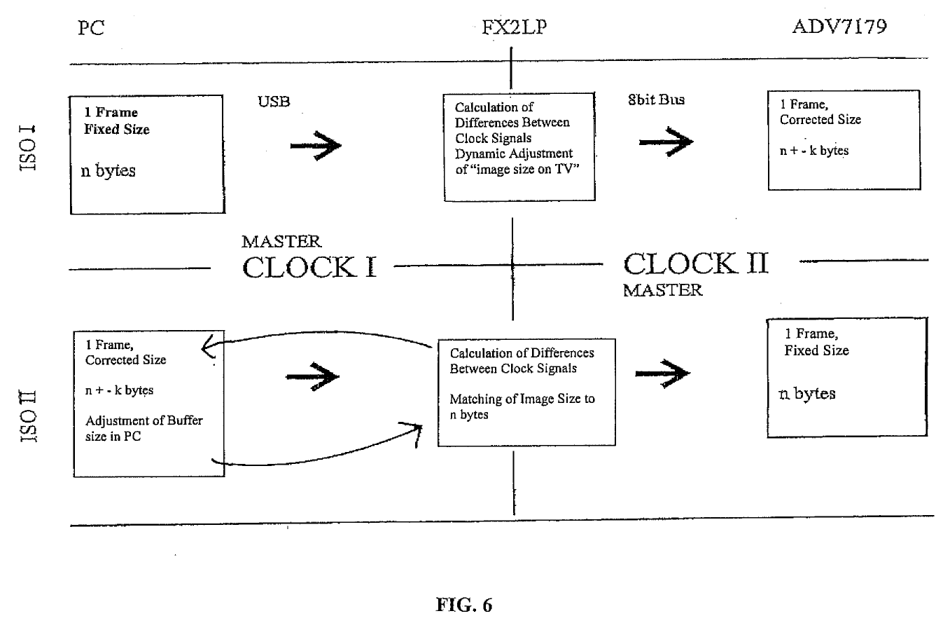

FIG. 6 is a block circuit diagram relating to the synchronisation between the data source and the data sink.

FIG. 1 shows the connections between a computer 1 having a monitor 1a connected to it, and a USB device 2 which is connected to the computer 1 by means of a USB cable 3. Connected to the USB device 2 by means of a video cable 4, e.g. an S-video cable, is a PAL or NTSC television set 5. The video cable 4 may of course equally well be replaced by an AV radio link, thus enabling the USB device 2 and the TV set 5 to be situated in different rooms. The USB connection is at least a USB 2.0 connection and may also be a wireless USB connection to the USB 3.0 standard.

FIG. 2 shows the general make-up of the digitised YUV video signal for a video image. The video image is transmitted in two halves, the top field and the bottom field. The top field, which is 720 pixels long, is transmitted first. An EAV signal follows the 720 pixels of image information. Following this EAV control data (EAV=end of active video) there is the 280 clock pulse long horizontal blanking interval in which the electron beam is moved back to the start of the next image line in cathode ray tube television sets. At the end of the horizontal blanking interval during which the “black” image signal is transmitted, the SAV (SAV=start of active video) control data follows. Once all the image lines in the top field have been transmitted, the vertical blanking interval VBI is transmitted. After this the bottom field and a fresh vertical blanking interval VBI are transmitted. A complete video image has thus been transmitted and the transmission of the next video image starts.

FIG. 3 is a block circuit diagram of the path followed by the data stream forming the video signal. For example, multimedia data in the AVI format is fed to an AVI splitter which splits the multimedia data into a video data stream and an audio data stream. The USB client renderer 8 converts the AVI video data into the YUV signal and transmits it to the Cypress USB driver 10, to which the audio data rendered by the direct sound renderer 9 is also transmitted. In the course of this, the data for the horizontal blanking interval is suppressed, ignored or not transmitted either back in the USB client renderer 8 or not until the Cypress USB driver is reached. Via the USB high-speed connection 11, the video and audio data is transmitted to the streaming client, i.e. data sink, 12. When this is done, data, and in particular control data, may also be transmitted back from the streaming client 12 to the computer 6, 7, 8, 9 to enable the multimedia data which is fed to the AVI splitter 6 to be controlled. The streaming client 12 reads the video and audio data which is transmitted and feeds it to its video and audio outputs 13 directly or via a video DAC.

FIG. 4 is a block circuit diagram of the streaming client 12 which has already been described by reference to FIG. 3. The video and audio data is fed to the streaming client 12 via the USB interface 11. The USB hub 14 feeds the audio data 14a to the USB audio controller 15 and the video data 14v to the USB video controller 18. In the USB video controller 18, the incoming data is written to the FIFO memory 20, from which it is emitted onto an 8-bit bus 21. An MPU 19 controls the FIFO memory 20 by reference to the data which has just been read out. If the EAV signal is detected, the read-out from the FIFO memory is stopped and, for a preset number of clock pulses, the freely programmable logic generates data words which correspond to the blanking interval of the YUV signal (pairs for words for “black”), and which are fed to the video encoder (video DAC) 24 at a frequency of 27 Mbyte/s. Following this, the read-out of the FIFO memory 20 is re-started and the data which is read out is fed to the video encoder 24, likewise at 27 Mbyte/s, until the EAV signal has again been read out of the FIFO memory and detected. The analogue video signal is available at the output 13v of the video encoder 24, duly processed for the PAL or NTSC system. Via the PC bus 25, control commands can be transmitted from the television set which is connected in, or by means of a remote control, to the streaming client 12 which, via the USB interface 11, transmits these commands to the computer for further processing.

As has already been explained, the data 23 is fed to the video encoder 24 at a band rate of 27 Mbyte/s. However, the visible data and control data are transmitted to the FIFO memory at a lower transmission rate, which means that theoretically the FIFO memory would empty. However, because the read-out of the FIFO memory 20 is always stopped for the generation of the data for the blanking interval, the FIFO memory 20 can be filled up again during this period, as shown in FIG. 5.

FIG. 6 shows the synchronisation of the data streams in the PC and in the USB device (FX2LP-ADV7179) for the first variant, in which the EAV and SAV control data is not used in controlling the USB controller of the USB client 2. The PC and the USB device each have a separate clock signal generator (Clock I and Clock II), neither of which runs exactly at the frequency of 27 MHz which is specified as a nominal reference clock frequency. Because of the differences between the system clock signals, different data rates arise in operation and because the USB controller (FX2LP) only has an 8 Kbyte memory these result in an overrun or underrun at the said USB controller. In the first variant, the differences between the clock signals are corrected for by means of a synchronization of the data source and data sink. If the horizontal blanking interval is not transmitted, the different data rate which arises due to the different system clock signals is corrected for as follows: The USB controller calculates the difference between the clock signals by measuring the length of each transmitted image line in a frame. This value is transmitted back to the PC for each line. The PC can correct for the upward/downward deviation of the data rate by varying the line length, which it does by also including a larger or smaller amount of data in the transmission for the next frame. It is immaterial in this case whether the data for the blanking interval, either all of it or only some of, is: not included in the transmission. The USB controller at the data sink generates the rest of the data, for the blanking interval, to bring the data rate to a figure of exactly 27 Mbyte/s for the video DAC. This synchronization always re-adjusts itself automatically with a small latency time.

1. A method of transmitting video data from a data source to a data sink in which the transmission is carried out via a USB interface, wherein the information is transmitted via the USB interface is digital values of a YUV signal, the digital values of the YUV signal being fed in the data sink to a video encoder, in the form in particular of a video DAC, the data being transmitted via the USB interface, and in particular via the USB 2.0 interface, in the isochronous or bulk transfer mode and, in the isochronous transfer mode, at least some, or all, of the data for the horizontal and/or vertical blanking interval of the YUV signal not being included in the transmission via the USB interface.

2. The method according to claim 1, wherein only chrominance and/or luminance information and data for image-end signals or image line-ends are transmitted via the USB interface.

3. The method according to claim 2, wherein before being fed to the video DAC, the data which is transmitted via the USB interface has the data of the YUV signal which was not included in the transmission added to it.

4. The method according to claim 1, wherein the video DAC converts the video YUV signal which has been completed in the data sink into a PAL or NTSC signal.

5. The method according to claim 1, wherein the difference in clock signals between the data source and data sink is corrected for by a synchronization between the data source and data sink.

6. The method according to claim 5, wherein a smaller or larger amount of data is transmitted to the data sink by the data source as a function of the difference in clock signals.

7. The method according to claim 1, wherein the data source determines the band width available on the USB transmission path and detects whether transmission can take place in the bulk transfer mode or the isochronous mode and selects the mode accordingly, no data being removed from the YUV signal in the bulk mode and the data sink thus not having to add any dada to the YUV signal.

8. The method according to claim 1, wherein the data source analyzes the YUV signal to be transmitted and filters all or some of the data for the horizontal and/or vertical blanking interval out of the YUV signal.

9. The method according to claim 8, wherein, on the data for the image-end signal or image line-end being detected, the succeeding data of the YUV signal is not transmitted until a value follows which differs from the values for a blanking interval of the YUV signal.

10. The method according to claim 8, wherein, each time the data for the image-end signal or image line-end has been detected, a certain number of succeeding items of data of the YUV signal are not transmitted and in that, following this, data of the YUV signal is transmitted again until such time as data for the image-end signal or image line-end is again detected.

11. The method according to claim 10, wherein the number of data words, i.e., bytes, not transmitted corresponds to the number of items of data in a conventional YUV signal which represent the blanking interval.

12. The method according to claim 9, wherein the data for the image-end signal or image line-end is included in the transmission via the USB interface.

13. The method according to claim 9, wherein the data sink has a FIFO memory which is associated in particular with the USB interface and in which the data transmitted is buffer stored, the data in the FIFO memory being read out and fed to the video DAC.

14. The method according to claim 13, wherein the data taken from the FIFO memory is analyzed and the read-out from the FIFO memory is stopped as soon as data for the image-end signal or image line-end is detected.

15. The method according to claim 14, wherein, while the read-out from the FIFO memory is stopped, the device forming the data sink generates a quantity of items of YUV blanking interval data which corresponds to the length of the blanking interval and feeds it to the video VAC.

16. The method according to claim 13, wherein the data sink has a control unit which analyzes the data coming from the FIFO memory and controls the FIFO memory and generates the data for the YUV blanking intervals.

17. The method according to claim 16, wherein the control unit feeds the data coming from the FIFO memory to the video DAC.

18. The method according to claim 13, wherein the items of data from the FIFO memory and from the control unit are fed alternately to the video DAC at a transmission rate of 27 Mbyte/s.

19. The method according to claim 16, wherein the control unit is formed by freely programmable logic and, in particular, by a complex programmable logic device (CPLD).

20. The method according to claim 1, wherein the USB controller of the data sink fills in the missing data for the blanking interval to generate a complete YUV signal.

21. The method according to claim 13, wherein the FIFO memory of the data sink is topped up or filled again by the data source after being partly emptied.

22. The method according to claim 1, wherein, to allow a PAL signal to be generated by means of the video DAC, a quantity of 1440 data words per image line and a quantity of at least eight words of control data are transmitted via the USB interface.

23. The method according to claim 1, wherein the data source is a computer and the data sink is a USB device.

24. The method according to claim 1, wherein the data source separates the video and audio data of a film from one another and transmits the audio data to the data sink via a USB interface separately from the video data.

25. The method according to claim 1, wherein the data sink transmits data via the USB interface to the data source, particularly for the control of the latter.

26. A device for carrying out the method according to claim 1, wherein the device is a USB device and forms the data sink, the device being formed by a USB interface, a control unit and, in particular, a CPLD or the USB controller, and having a video DAC, and the control unit controlling the FIFO memory.

27. A device according to claim 26, wherein, to form a PAL signal, the control unit generates sequences of 280 bytes of YUV blanking interval data, and feeds them to the video DAC at a transmission rate of 27 Mbyte/s alternately with the image-line data and control data which is stored in the FIFO memory.

28. A device according to claim 26, wherein the control unit analyzes the image-line data and control data which is stored in the FIFO memory or comes from the FIFO memory and when control data is detected, interrupts the read-out from the FIFO memory to allow YUV blanking interval data to be generated.

29. A device for carrying out the method according to claim 1, wherein the device is a computer which forms the data source, software being installed on the computer which feeds all the digitized YUV signal data to the USB driver except the data for the YUV blanking intervals.

30. A device according to claim 29, wherein the computer supplements the video image to be transmitted with additional image information, in which case the additional image information may be a menu for selection or an on-screen display.
